(19) United States
(12) Patent Application Publication
(10) Pub. No.: US 2015/0272814 A1
(43) Pub. Date: Oct. 1, 2015

(54) Clamping-Style Neck-Back-Waist-Leg Massager

(71) Applicant: ST LIFE CO., LTD., Changhua County (TW)

(72) Inventor: Jue-Yao Chen, Changhua County (TW)

(73) Assignee: ST LIFE CO., LTD., Changhua County (TW)

(21) Appl. No.: 14/225,497

(22) Filed: Mar. 26, 2014

(51) Int. Cl. A61H 15/00; A61H 7/00

(52) U.S. Cl. CPC A61H 15/0092; A61H 7/001; A61H 2201/1611; A61H 2201/1626; A61H 2201/163; A61H 2201/1642; A61H 2201/0153

(57) ABSTRACT

A clamping-style neck-back-waist-leg massager includes: a frame flanked by two handles; a central shaft pivotally connected to a rotational center of a torsional spring; a right clamper having leftward a pivot ear hole pivotally connected to the central shaft and abutted against a first free end of the torsional spring and having rightward a free end bending away from the corresponding handle; a left clamper having rightward a pivot ear hole pivotally connected to the central shaft and abutted against a second free end of the torsional spring and having leftward a free end bending away from the corresponding handle. The free ends of the right and left clampers approach each other to effectuate clamping. The right and left clampers have therein first and second massaging sets extending outward to form first and second massaging units, respectively, for performing fixed-point or transverse massage on the neck, back, waist, and legs.

### BACKGROUND OF THE INVENTION

1. Technical Field

The present invention relates to the technical field of massagers, and more particularly, to a clamping-style neck-back-waist-leg massager which clamps the neck, back, waist, and legs from two opposite sides and comprises two massaging units for performing fixed-point or transverse massage from two opposite sides.

2. Description of Related Art

People living in a modern industrialized and commercial society usually lead a stressful and busy lifestyle and thus fall victim to physical and mental fatigue. Mental fatigue can be relieved by taking a brief rest. By contrast, physical fatigue can be alleviated by massage only. Conventional massaging tools are simple in how they work, unvarying in how they look, and monotonous in providing massage options. As a result, consumers go for a dedicated massager that massages the back and another dedicated massager that massages the legs, thereby causing a waste of money and taking up much space. In view of this, there is still room for improvement in the prior art.

Conventional massaging tools include large massaging tools, such as massage chairs and massage beds. Although the aforesaid massaging tools are effective in massaging the neck, back, and legs, they take up much space, look unpleasant when idle, and incur expenditure too much to be affordable to the man in the street. Furthermore, the aforesaid dedicated massagers are not collectively cost-effective.

### SUMMARY OF THE INVENTION

It is an objective of the present invention to provide a clamping-style neck-back-waist-leg massager which comprises left and right clampers, a frame, and two massaging units. The left and right clampers clamp the neck, back, waist, and legs from two opposite sides. A user grips handles on two sides of the frame to control the strength of a massaging force applied. The two massaging units perform fixed-point or transverse massage from two opposite sides.

In order to achieve the above and other objectives, the present invention provides a clamping-style neck-back-waist-leg massager, comprising: a frame being slender and curvy and flanked by two handles; a central shaft pivotally connected to a rotational center of a torsional spring; a right clamper having leftward a pivot ear hole pivotally connected to the central shaft and abutted against by a first free end of the torsional spring, the right clamper having rightward a free end bending away from the corresponding handle, the right clamper having therein a first massaging set, the first massaging set extending outward to form a first massaging unit, the first massaging unit performing fixed-point or transverse massage on the neck, the back, the waist, and the legs rearward and rightward; a left clamper having rightward a pivot ear hole pivotally connected to the central shaft and abutted against by a second free end of the torsional spring, the left clamper having leftward a free end bending away from the corresponding handle, such that the free ends disposed rightward and leftward at the right and left clampers, respectively, get closer to each other so as to effectuate clamping, the left clamper having therein a second massaging set, the second massaging set extending outward to form a second massaging unit, the second massaging unit performing fixed-point or transverse massage on the neck, the back, the waist, and the legs rearward and leftward.

### BRIEF DESCRIPTION OF THE DRAWINGS

FIG. 1 is a schematic perspective view of a clamping-style neck-back-waist-leg massager according to an embodiment of the present invention;

FIG. 2 is an exploded view of the clamping-style neck-back-waist-leg massager according to the embodiment of the present invention;

FIG. 3 is an exploded view of right and left clampers according to the embodiment of the present invention;

FIG. 4 is an exploded view of a first massaging set according to the embodiment of the present invention;

FIG. 5 is an exploded view of a second massaging set according to the embodiment of the present invention;

FIG. 6 is a partial schematic perspective view of the first massaging set according to the embodiment of the present invention;

FIG. 7 is a cross-sectional plan view of the clamping-style neck-back-waist-leg massager according to the embodiment of the present invention;

FIG. 8 is a schematic view of the clamping-style neck-back-waist-leg massager which flexes and extends based on the outline of the human body according to the embodiment of the present invention;

FIG. 9 is a schematic view of the first and second massaging sets performing transverse massage according to the embodiment of the present invention;

FIG. 10 is a schematic view of the clamping-style neck-back-waist-leg massager massaging the shoulders and neck according to the embodiment of the present invention;

FIG. 11 is a schematic view of the clamping-style neck-back-waist-leg massager massaging the waist according to the embodiment of the present invention; and

FIG. 12 is a schematic view of the clamping-style neck-back-waist-leg massager massaging the legs according to the embodiment of the present invention.

### DETAILED DESCRIPTION OF THE EMBODIMENT OF THE INVENTION

The present invention provides a clamping-style neck-back-waist-leg massager.

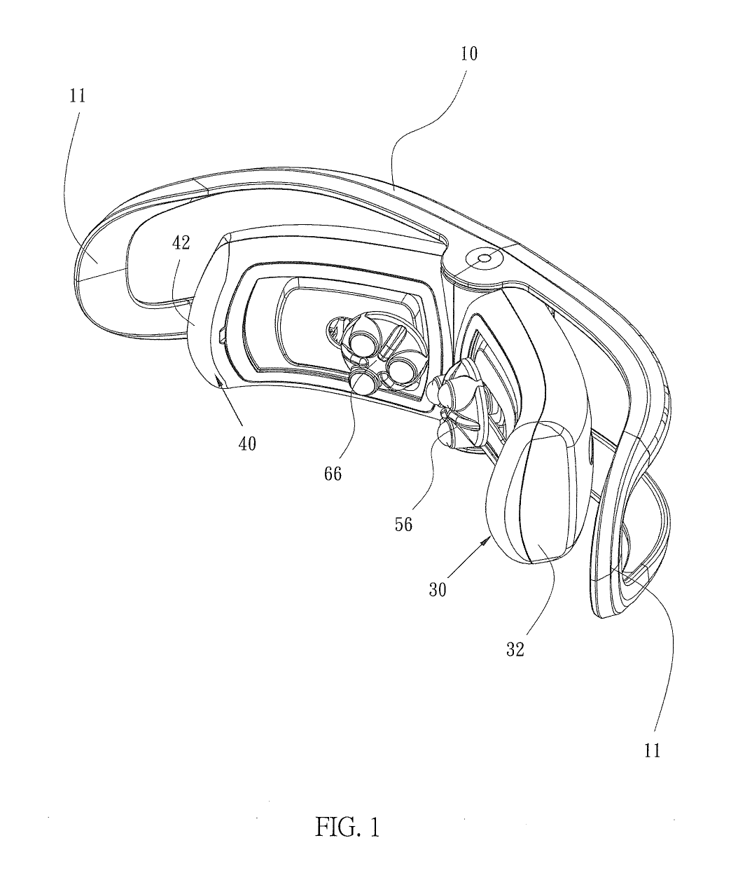

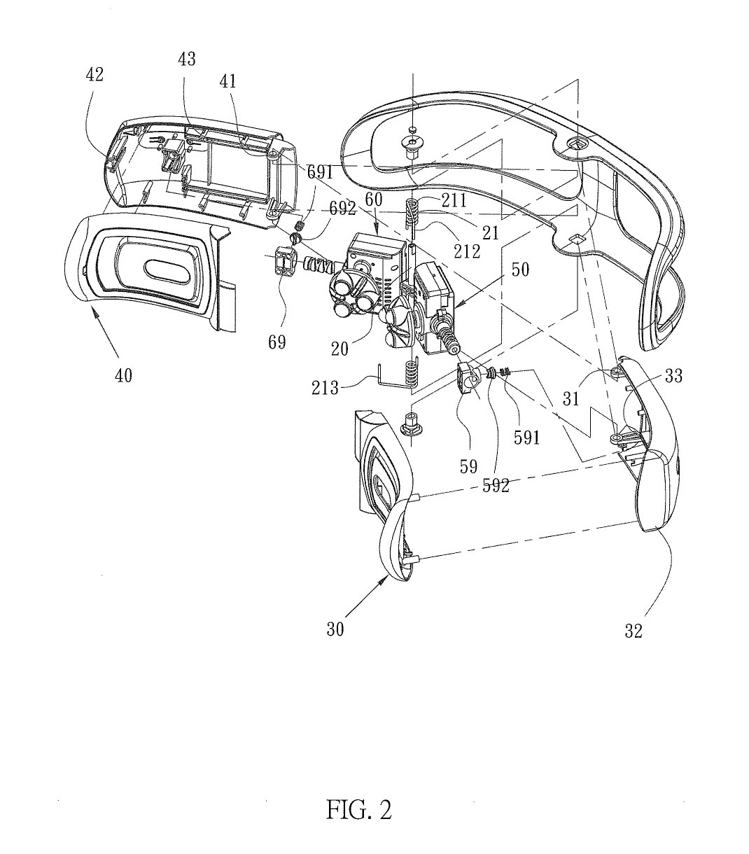

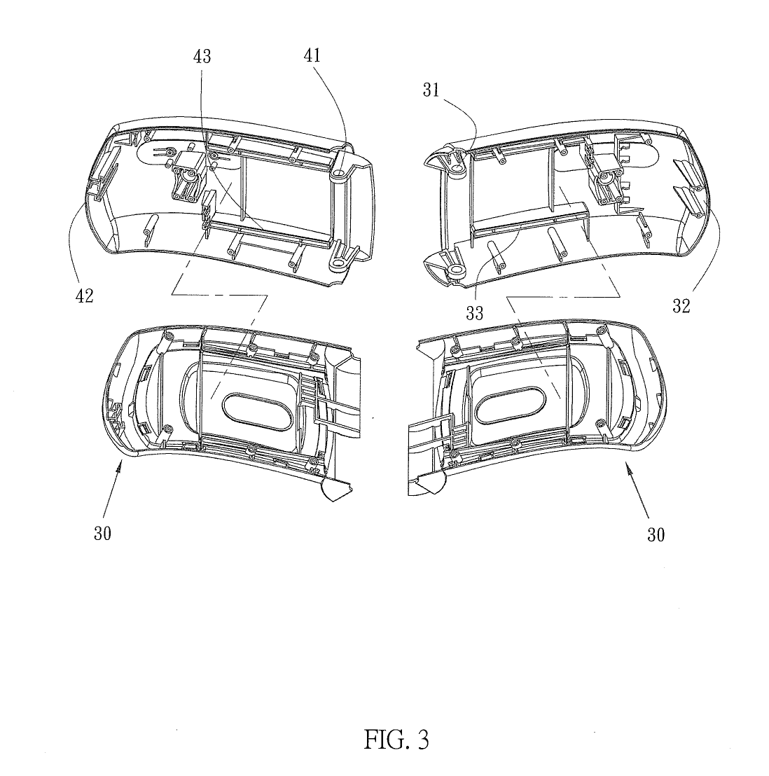

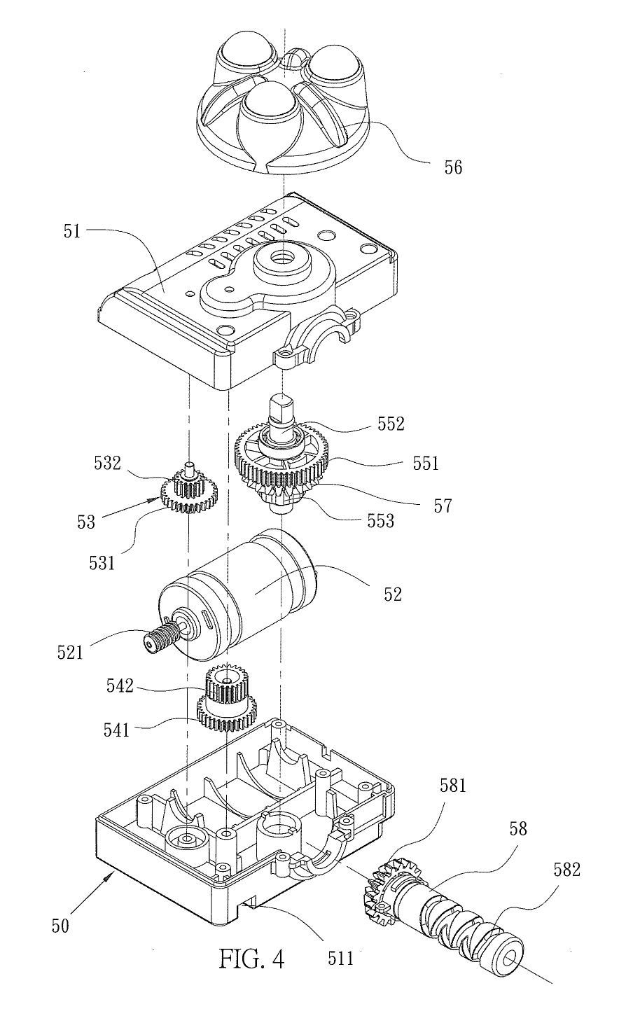

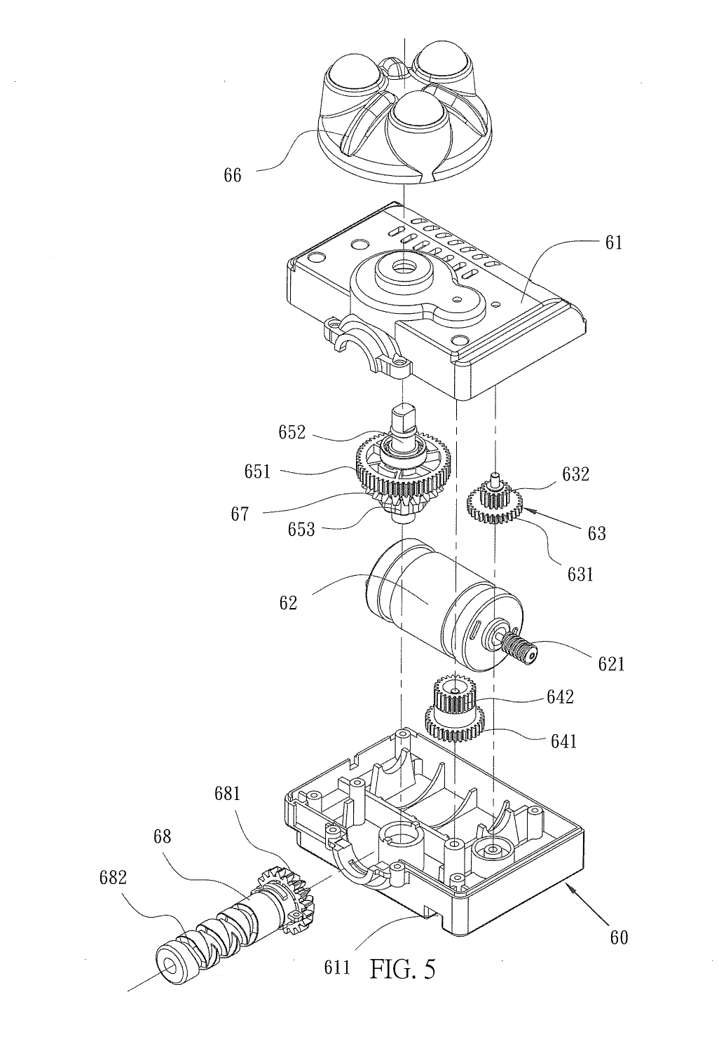

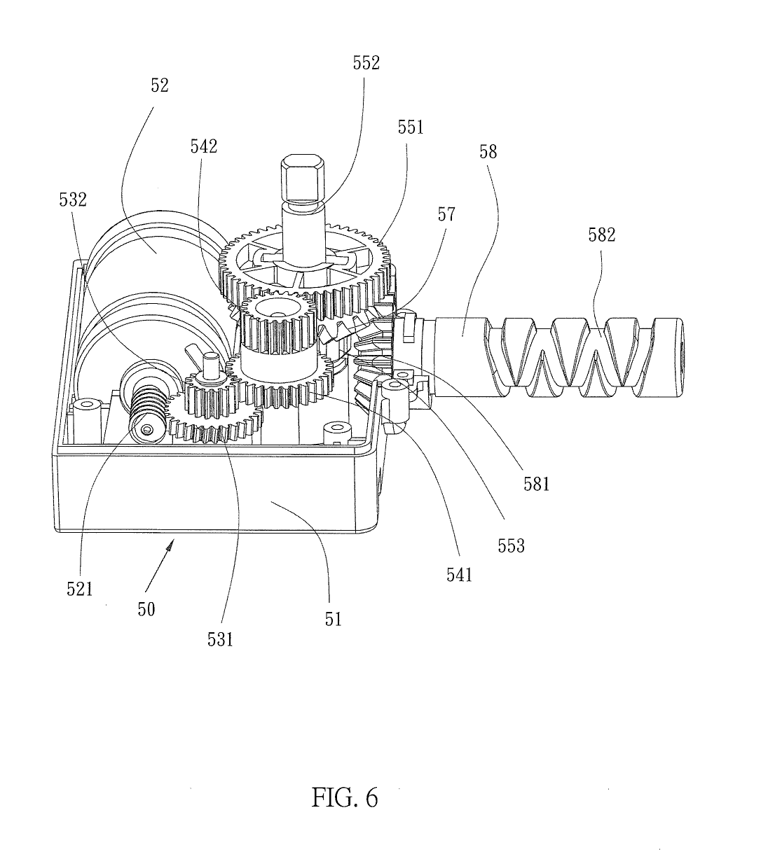

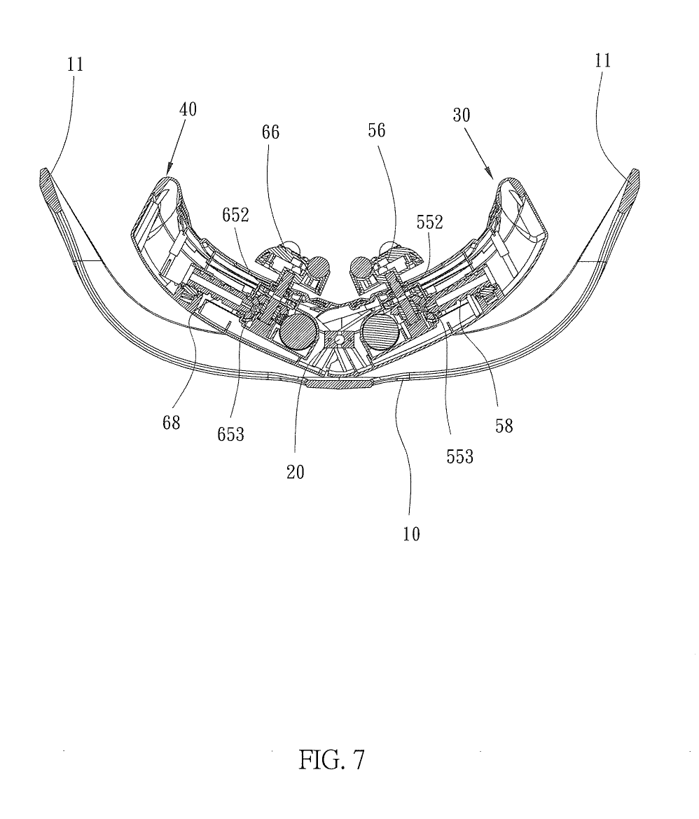

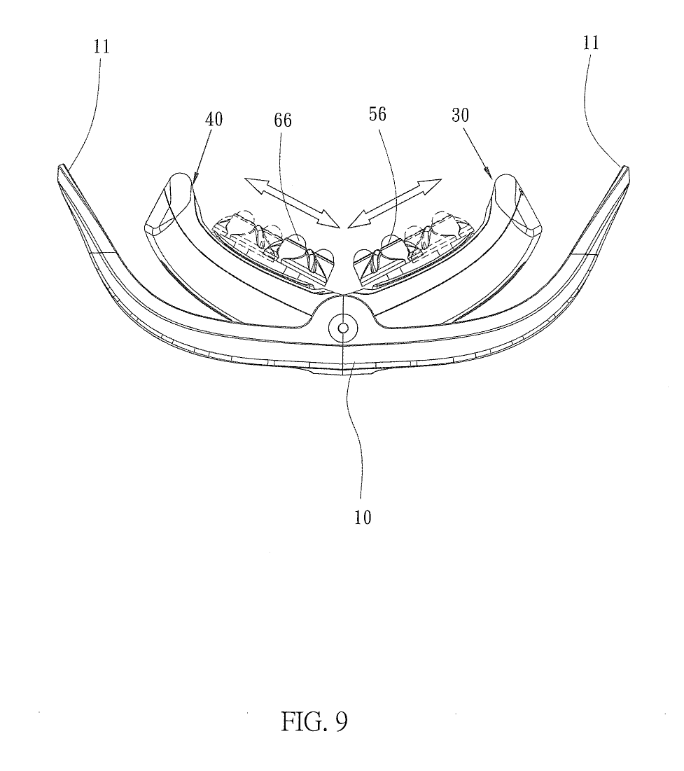

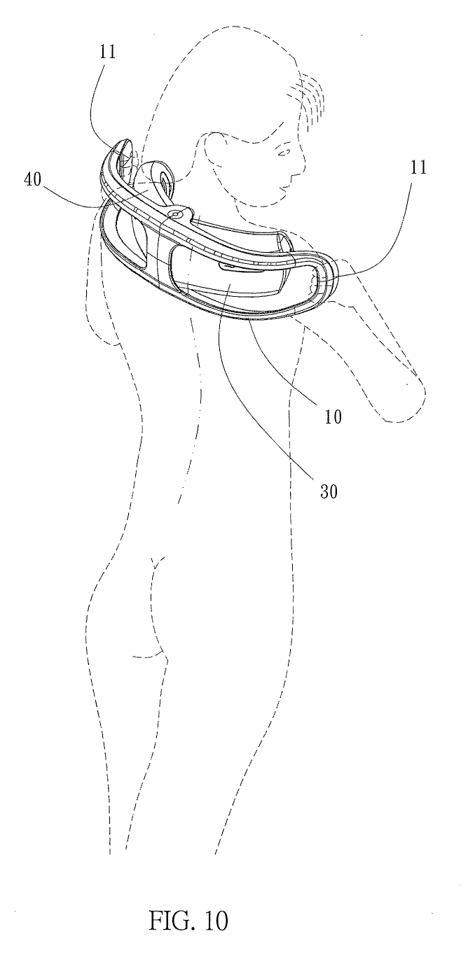

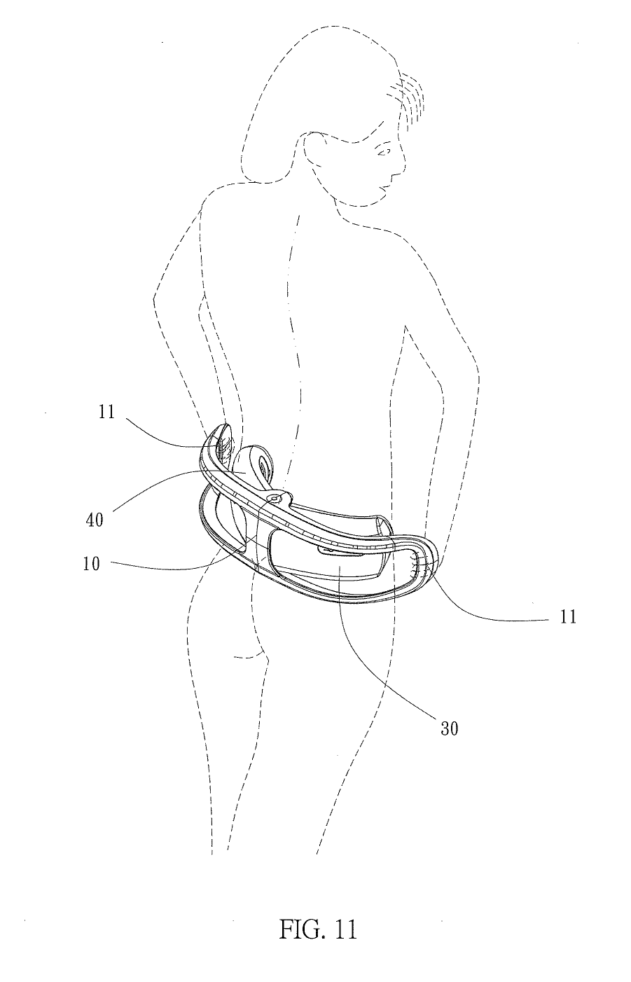

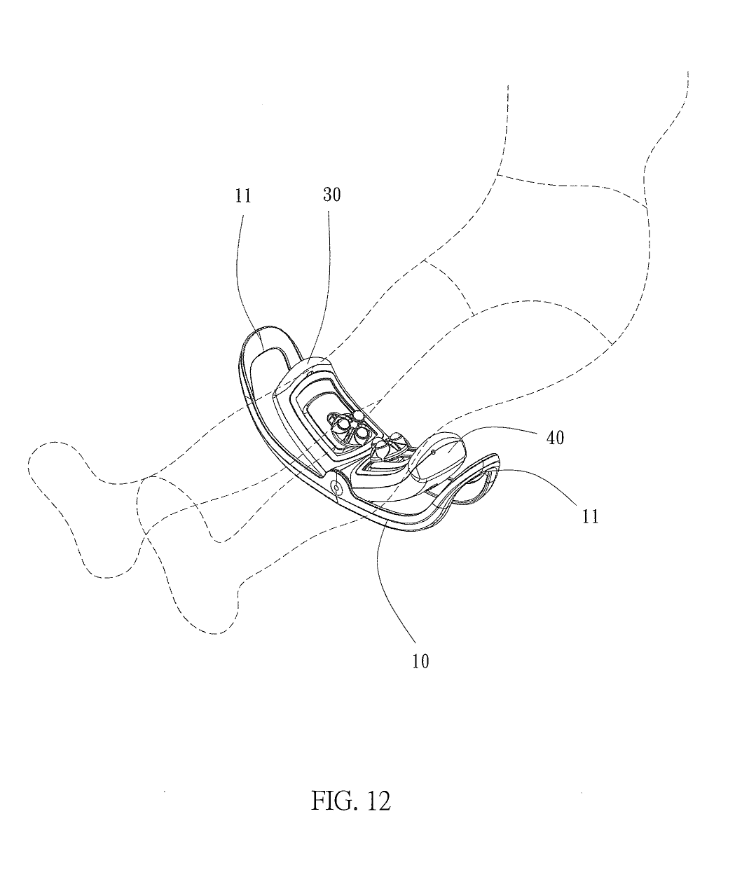

Referring to FIG. 1 through FIG. 12, the present invention provides a clamping-style neck-back-waist-leg massager, comprising a frame 10, a central shaft 20, a right clamper 30, and a left clamper 40.

The frame 10 looks slender and curvy. Two handles 11 flank the frame 10.

The central shaft 20 is fixed to the frame 10 centrally. The central shaft 20 is pivotally connected to a rotational center 211 of at least a torsional spring 21.

The right clamper 30 has leftward a pivot ear hole 31 pivotally connected to the central shaft 20 and abutted against by a first free end 212 of the torsional spring 21, such that the right clamper 30 has rightward a free end 32 bending away from the corresponding handle 11. The right clamper has therein a first massaging set 50. The first massaging set 50 extends outward to form a first massaging unit 56. The first massaging unit 56 performs fixed-point or transverse massage on the neck, the back, the waist, and the legs rearward and rightward.

The left clamper 40 has rightward a pivot ear hole 41 pivotally connected to the central shaft 20 and abutted against by a second free end 213 of the torsional spring 21, such that the left clamper 40 has leftward a free end 42 bending away from the corresponding handle 11. Hence, the free ends 32, 42 rightward and leftward disposed at the right and left clampers 30, 40, respectively, can get closer to each other so as to effectuate clamping. The left clamper 40 has therein a second massaging set. The second massaging set extends outward to form a second massaging unit. The second massaging unit performs fixed-point or transverse massage on of the neck, the back, the waist, and the legs rearward and leftward.

The first massaging set 50 comprises a first casing portion 51. The right clamper 30 has therein a rail 33 transversely corresponding in position to the first casing portion 51. The first casing portion 51 has a first sliding groove 511 slidably disposed at the rail 33. The first casing portion 51 has therein a first gear train 53 comprising a second lower gear 531, a second upper gear 532 integrally formed with the second lower gear 531, a third lower gear 541, a third upper gear 542 integrally formed with the third lower gear 541, and a fourth gear 551. The first casing portion 51 has therein a first motor 52 with a first worm 521 which meshes and drives the second lower gear 531 to thereby allow the second upper gear 532 to mesh and drive the third lower gear 541, and thereby allow the third upper gear 542 to mesh and drive the fourth gear 551. Hence, a fourth gear shaft 552 fixed to the fourth gear 551 drives the first massaging unit 56 and a first one-way bearing 553. The first one-way bearing 553 drives a first bevel gear 57. A first Y-shaped groove lead screw 58 has an end fixed to a second bevel gear 581. The first Y-shaped groove lead screw 58 penetrates and protrudes from the first casing portion 51. The first and second bevel gears 57, 581 mesh and drive each other. The first Y-shaped groove lead screw 58 has another end provided with a first supporting base 59. The first supporting base 59 has therein a first spring 591 abutting against a first serrated block 592 and causing the first serrated block 592 to mesh with a first Y-shaped groove 582 of the first Y-shaped groove lead screw 58. Hence, as soon as the first serrated block 592 is fixed in place and the first Y-shaped groove lead screw 58 starts to rotate, the first serrated block 592 abuts against the first Y-shaped groove lead screw 58 to cause the first Y-shaped groove lead screw 58 to get transverse leftward until the limit is reached, and then the first Y-shaped groove lead screw 58 becomes transverse rightward, thereby allowing the cycle to repeat. The first worm 521 of the first motor 52 drives the first gear train 53 to drive the fourth gear shaft 552 to rotate clockwise and thereby drive the first one-way bearing 553 to rotate, whereas the first one-way bearing 553 drives the first and second bevel gears 57, 581 and the first Y-shaped groove lead screw 58 to rotate. Hence, the first Y-shaped groove lead screw 58 gets driven by the first casing portion 51 to become transverse leftward until the limit is reached. Then, the first Y-shaped groove lead screw 58 becomes transverse rightward, thereby allowing the cycle to repeat. The fourth gear shaft 552 drives the first massaging unit 56 to perform rotational massage and thus effectuate a mode of leftward transverse rightward massage. If the first worm 521 of the first motor 52 drives the first gear train 53 to drive the fourth gear shaft 552 to rotate anticlockwise, the first one-way bearing 553 idles, whereas the first casing portion 51 is stationary, such that the fourth gear shaft 552 drives the first massaging unit 56 to perform rotational massage and thus effectuate a mode of fixed-point massage.

The second massaging set 60 comprises a second casing portion 61. The left clamper 40 has therein a rail 43 transversely corresponding in position to the second casing portion 61. The second casing portion 61 has a second sliding groove 611 slidably disposed at the rail 43. The second casing portion 61 has therein a second gear train 63 comprising a fifth lower gear 631, a fifth upper gear 632 integrally formed with the fifth lower gear 631, a sixth lower gear 641, a sixth upper gear 642 integrally formed with the sixth lower gear 641, and a seventh gear 651. The second casing portion 61 has therein a second motor 62 with a second worm 621 which meshes and drives the fifth lower gear 631 to thereby allow the fifth upper gear 632 to mesh and drive the sixth lower gear 641, and thereby allow the sixth upper gear 642 to mesh and drive the seventh gear 651. Hence, a seventh gear shaft 652 fixed to the seventh gear 551 drives a second massaging unit 66 and a second one-way bearing 653. The second one-way bearing 653 drives a third bevel gear 67. A second Y-shaped groove lead screw 68 has an end fixed to a fourth bevel gear 681. The second Y-shaped groove lead screw 68 penetrates and protrudes from the second casing portion 61. The third and fourth bevel gears 67, 681 mesh and drive each other. The second Y-shaped groove lead screw 68 has another end provided with a second supporting base 69. The second supporting base 69 has therein a second spring 691 abutting against a second serrated block 692 and causing the second serrated block 692 to mesh with a second Y-shaped groove 682 of the second Y-shaped groove lead screw 68. Hence, as soon as the second serrated block 692 is fixed in place and the second Y-shaped groove lead screw 68 starts to rotate, the second serrated block 692 abuts against the second Y-shaped groove lead screw 68 to cause the second Y-shaped groove lead screw 68 to get transverse leftward until the limit is reached, and then the second Y-shaped groove lead screw 68 becomes transverse rightward, thereby allowing the cycle to repeat. The second worm 621 of the second motor 62 drives the second gear train 63 to drive the seventh gear shaft 652 to rotate clockwise and thereby drive the second one-way bearing 653 to rotate. Hence, the second one-way bearing 653 drives the third and fourth bevel gears 67, 681 and the second Y-shaped groove lead screw 68 to rotate, and thus the second casing portion 61 is driven by the second Y-shaped groove lead screw 68 to get transverse leftward until the limit is reached, and then the second Y-shaped groove lead screw 68 becomes transverse rightward, thereby allowing the cycle to repeat. The seventh gear shaft 652 drives the second massaging unit 66 to perform rotational massage and thus effectuate a mode of leftward transverse rightward massage. If the second worm 621 of the second motor 62 drives the second gear train 63 to drive the seventh gear shaft 652 to rotate anticlockwise, the second one-way bearing 653 idles, whereas the second casing portion 61 is stationary, such that the seventh gear shaft 652 drives the second massaging unit 66 to perform rotational massage and thus effectuate a mode of fixed-point massage.

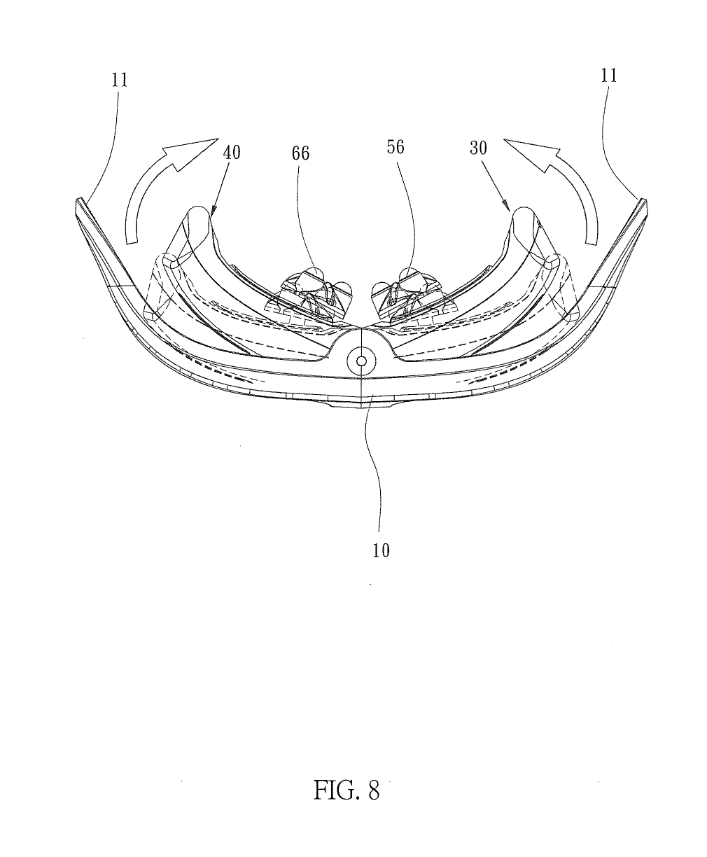

Referring to FIG. 8 through FIG. 12, the clamping-style neck-back-waist-leg massager of the present invention flexes and extends based on the outline of the human body, such that the first and second massaging units 56, 66 can effectively massage the acupoints of the human body. The user exerts an appropriate force on the two handles 11 of the frame 10 to speed up the achievement of benefits of massage. The first and second massaging units 56, 66 perform fixed-point or transverse massage on the shoulders, the neck, the waist, and the legs selectively to bring the advantages of the massager into full play.

What is claimed is:

1. A clamping-style neck-back-waist-leg massager, comprising:
a frame being slender and curvy and flanked by two handles;
a central shaft fixed to the frame centrally and pivotally connected to a rotational center of at least a torsional spring;
a right clamper having leftward a pivot ear hole pivotally connected to the central shaft and abutted against by a first free end of the torsional spring, the right clamper having rightward a free end bending away from the corresponding handle, the right clamper having therein a first massaging set, the first massaging set extending outward to form a first massaging unit, the first massaging unit performing fixed-point or transverse massage on the neck, the back, the waist, and the legs rearward and rightward; and
a left clamper having rightward a pivot ear hole pivotally connected to the central shaft and abutted against by a second free end of the torsional spring, the left clamper having leftward a free end bending away from the corresponding handle, such that the free ends disposed rightward and leftward at the right and left clampers, respectively, get closer to each other so as to effectuate clamping, the left clamper having therein a second massaging set, the second massaging set extending outward to form a second massaging unit, the second massaging unit performing fixed-point or transverse massage on the neck, the back, the waist, and the legs rearward and leftward.

2. The clamping-style neck-back-waist-leg massager of claim 1, wherein the first massaging set comprises a first casing portion, the right clamper having therein a plurality of rails transversely corresponding in position to the first casing portion, the first casing portion having a plurality of first sliding grooves slidably disposed at the rails, respectively, the first casing portion having therein a first gear train, the first casing portion having therein a first motor with a first worm meshing and driving the first gear train, the first gear train being fixed to a fourth gear shaft, the fourth gear shaft driving the first massaging unit and a first one-way bearing, the first one-way bearing driving a first bevel gear, a first Y-shaped groove lead screw having an end fixed to a second bevel gear, such that the first Y-shaped groove lead screw penetrates and protrudes from the first casing portion, the first and second bevel gears meshing and driving each other, the first Y-shaped groove lead screw having another end provided with a first supporting base, the first supporting base having therein a first spring abutting against a first serrated block and causing the first serrated block to mesh with a first Y-shaped groove of the first Y-shaped groove lead screw.

3. The clamping-style neck-back-waist-leg massager of claim 2, wherein the first gear train comprises a second lower gear, a second upper gear integrally formed with the second lower gear, a third lower gear, a third upper gear integrally formed with the third lower gear, and a fourth gear, the first worm meshing and driving the second lower gear, the second upper gear meshing and driving the third lower gear, the third upper gear meshing and driving the fourth gear, and the fourth gear being fixed to the fourth gear shaft.

4. The clamping-style neck-back-waist-leg massager of claim 1, wherein the second massaging set comprises a second casing portion, the left clamper having therein a plurality of rails transversely corresponding in position to the second casing portion, the second casing portion having therein a plurality of second sliding grooves slidably disposed at the rails, respectively, and the second casing portion having therein a second gear train, the second casing portion having therein a second motor with a second worm meshing and driving the second gear train, the second gear train being fixed to a seventh gear shaft, the seventh gear shaft driving the second massaging unit and a second one-way bearing, the second one-way bearing driving a third bevel gear, wherein an end of a second Y-shaped groove lead screw is fixed to a fourth bevel gear, such that the second Y-shaped groove lead screw penetrates and protrudes from the second casing portion, the third and fourth bevel gear meshing and driving each other, wherein another end of the second Y-shaped groove lead screw is provided with a second supporting base, the second supporting base having therein a second spring abutting against a second serrated block, such that the second serrated block meshes with a second Y-shaped groove of the second Y-shaped groove lead screw.

5. The clamping-style neck-back-waist-leg massager of claim 4, wherein the second gear train comprises a fifth lower gear, a fifth upper gear integrally formed with the fifth lower gear, a sixth lower gear, a sixth upper gear integrally formed with the sixth lower gear, and a seventh gear, the second worm meshing and driving the fifth lower gear, the fifth upper gear meshing and driving the sixth lower gear, the sixth upper gear meshing and driving the seventh gear, and the seventh gear being fixed to the seventh gear shaft.

6. A clamping-style neck-back-waist-leg massager, comprising:
a frame being slender and curvy and flanked by two handles;
a central shaft fixed to the frame centrally and pivotally connected to a rotational center of at least a torsional spring;
a right clamper having leftward a pivot ear hole pivotally connected to the central shaft and abutted against by a first free end of the torsional spring, the right clamper having rightward a free end bending away from the corresponding handle, the right clamper having therein a first massaging set, the first massaging set extending outward to form a first massaging unit, the first massaging unit performing fixed-point or transverse massage on the neck, the back, the waist, and the legs rearward and rightward, the first massaging set comprising a first casing portion, the right clamper having therein a plurality of rails transversely corresponding in position to the first casing portion, the first casing portion having a plurality of first sliding grooves slidably disposed at the rails, respectively, the first casing portion having therein a first gear train, the first casing portion having therein a first motor with a first worm meshing and driving the first gear train, the first gear train being fixed to a fourth gear shaft, the fourth gear shaft driving the first massaging unit and a first one-way bearing, the first one-way bearing driving a first bevel gear, a first Y-shaped groove lead screw having an end fixed to a second bevel gear, the first Y-shaped groove lead screw penetrating and protruding from the first casing portion, the first and second bevel gears meshing and driving each other, the first Y-shaped groove lead screw having another end provided with a first supporting base, the first supporting base having therein a first spring abutting against a first serrated block, the first serrated block meshing with a first Y-shaped groove of the first Y-shaped groove lead screw, the first gear train comprising a second lower gear, a second upper gear integrally formed with the second lower gear, a third lower gear, a third upper gear integrally formed with the third lower gear, and a fourth gear, the first worm meshing and driving the second lower gear, the second upper gear meshing and driving the third lower gear, the third upper gear meshing and driving the fourth gear, and the fourth gear being fixed to the fourth gear shaft; and
a left clamper having rightward a pivot ear hole pivotally connected to the central shaft and abutted against by a second free end of the torsional spring, the left clamper having leftward a free end bending away from the corresponding handle, such that the free ends rightward and leftward disposed at the right and left clampers, respectively, get closer to each other so as to effectuate clamping, the left clamper having therein a second massaging set, the second massaging set extending outward to form a second massaging unit, the second massaging unit performing fixed-point or transverse massage on the neck, the back, the waist, and the legs rearward and leftward, the second massaging set comprising a second casing portion, the left clamper having therein a plurality of rails transversely corresponding in position to the second casing portion, the second casing portion having a plurality of second sliding grooves slidably disposed at the rails, respectively, the second casing portion having therein a second gear train, the second casing portion having therein a second motor with a second worm meshing and driving the second gear train, the second gear train being fixed to a seventh gear shaft, the seventh gear shaft driving the second massaging unit and a second one-way bearing, the second one-way bearing driving a third bevel gear, a second Y-shaped groove lead screw having an end fixed to a fourth bevel gear, the second Y-shaped groove lead screw penetrating and protruding from the second casing portion, the third and fourth bevel gears meshing and driving each other, the second Y-shaped groove lead screw having another end provided with a second supporting base, the second supporting base having therein a second spring abutting against a second serrated block, the second serrated block meshing with a second Y-shaped groove of the second Y-shaped groove lead screw, the second gear train comprising a fifth lower gear, a fifth upper gear integrally formed with the fifth lower gear, a sixth lower gear, a sixth upper gear integrally formed with the sixth lower gear, and a seventh gear, the second worm meshing and driving the fifth lower gear, the fifth upper gear meshing and driving the sixth lower gear, the sixth upper gear meshing and driving the seventh gear, and the seventh gear being fixed to the seventh gear shaft.
